(19) United States
(12) Patent Application Publication
(10) Pub. No.: US 2020/0344289 A1
(43) Pub. Date: Oct. 29, 2020

(54) DYNAMIC NETWORK CONFIGURATION AND SERVER EXTENSION METHOD AND SYSTEM

(71) Applicant: Center of Human-centered Interaction for Coexistence, Seoul (KR)

(72) Inventors: Tae Young LEE, Seoul (KR); Eun Mi LEE, Seoul (KR); Jae Heung SURH, Seoul (KR); Joong Jae LEE, Seoul (KR); Bum Jae YOU, Seoul (KR)

(21) Appl. No.: 16/563,541

(22) Filed: Sep. 6, 2019

(30) Foreign Application Priority Data
Apr. 26, 2019 (KR) 10-2019-0049151

(51) Int. Cl. H04L 29/08; H04L 12/24

(52) U.S. Cl. CPC H04L 67/1008; H04L 67/16; H04L 41/082; H04L 67/2838; H04L 67/20

(57) ABSTRACT

Provided is a dynamic network configuration and server extension system. The dynamic network configuration and server extension system includes a plurality of service servers configured to provide a request service according to a service request; and a management server configured to provide session information of a configuration which is dynamically transmitted by a buffer on a memory for the plurality of service servers providing the requested service and operate additionally the service server in proportional to the service request to extend the server. According to the present disclosure, it is possible to provide a service desired by a user (client) through a wired/wireless dynamic environment configuration method and a wired/wireless load distribution server management function.

### CROSS-REFERENCE TO RELATED APPLICATIONS

This application claims the priority of Korean Patent Application No. 10-2019-0049151 filed on Apr. 26, 2019, in the Korean Intellectual Property Office, the disclosure of which is incorporated herein by reference.

### BACKGROUND

### Field

The present disclosure relates to a dynamic network configuration and server extension method and, more particularly, to a dynamic network configuration and server extension method capable of providing a service desired by a user (client) through a wired/wireless dynamic environment configuration method and a wired/wireless load distribution server management function so as to be suitable for the service desired by the user.

### Description of the Related Art

A network configuration and processing method in the related art is a method in which a user accesses an IP or a port of an access server and the processing method thereof is constant.

More specifically, as illustrated in FIG. 1A, Client 2 may access a desired service A server in order to receive the desired service A.

Then, Client 7 tries to access the desired service A server in order to receive the desired service A as illustrated in FIG. 1B, but the service A server is already accessed by the maximum number of users, and thus the Client 7 may not access the service A server (IP: 10.18.0.165).

In the network configuration and processing method in the related art, there is a problem that it is difficult to maintain configuration information when the number of provided services is increased or changed.

### SUMMARY

An object to be achieved by the present disclosure is to provide a dynamic network configuration and server extension system and a method thereof capable of providing a service desired by a user (client) through a wired/wireless dynamic environment configuration method and a wired/wireless load distribution server management function so as to be suitable for the service desired by the user.

According to an aspect of the present disclosure, there is provided a dynamic network configuration and server extension system. The dynamic network configuration and server extension system includes: a plurality of service servers configured to provide a request service according to a service request; and a management server configured to provide session information of a configuration which is dynamically transmitted by a buffer on a memory for the plurality of service servers providing the requested service and operate additionally the service server in proportion to the service request to extend the server.

Preferably, the dynamic network configuration and server extension system may further include a plurality of client terminals configured to request session information as access information about the plurality of service servers providing the service by accessing the management server and receive the service by accessing a service server accessible according to the corresponding session information.

Preferably, the management server may be managed by a global server management unit, and the global server management unit includes: an access management unit configured to provide the session information to a request of the access information to the service server of the client terminal; a monitoring unit configured to determine access change information of the client terminal accessing the service server through monitoring to update a status of the service server; and a load balancing unit configured to distribute a load by additionally operating another service server when all client terminals to be accessible access the service server and are not accessible anymore.

Preferably, the global server management unit may further include a restoring unit configured to restore the corresponding service server when the service server is shut down due to over-access of the plurality of client terminals; and a service and server information DB configured to receive information about the plurality of service servers from the local server management unit of the service server to store and manage the received information.

More preferably, the dynamic network configuration and server extension system may further include a lobby server formed between the client terminal and the management server and configured to inquire services which have been previously provided when the client terminal is accessed and classify the services as a related service providing sector to provide the services or inform pre-access or post-access information of a friend.

According to another aspect of the present disclosure, there is provided a dynamic network configuration and server extension method. The dynamic network configuration and server extension method includes: (a) requesting, by a management server, access information to a service server from a client terminal and inquiring a service and server information DB; (d) providing, by the management server, session information of a configuration which is dynamically transmitted to the client terminal by a buffer on a memory as the access information; and (e) providing, by the service server, a service to a client terminal to be accessed on the basis of the session information.

The dynamic network configuration and server extension method may further include (b) additionally operating, by a load balancing unit of a global server management unit managing the management server, another service server by transmitting an execution signal to a local server management unit which manages a service server when there is no accessible service server, after step (a).

Preferably, the dynamic network configuration and server extension method may further include (c) updating, by the global server management unit, a service and server information DB of the management server by receiving information about the service server additionally operated from the local server management unit, after step (b).

Preferably, the dynamic network configuration and server extension method may further include (f) transmitting, by the local server management unit, access change information about the service server to the management server, after confirming an access of the client terminal, after step (e).

More preferably, the dynamic network configuration and server extension method may further include (g) updating, by the global server management unit of the management server, a service and server information DB by reflecting the access change information of the client terminal transmitted from the local server management unit, after step (f).

According to the present disclosure, in the dynamic network configuration and server extension method and the system thereof, it is possible to provide a service desired by a user (client) through a wired/wireless dynamic environment configuration method and a wired/wireless load distribution server management function.

### BRIEF DESCRIPTION OF THE DRAWINGS

The above and other aspects, features and other advantages of the present disclosure will be more clearly understood from the following detailed description taken in conjunction with the accompanying drawings, in which:

FIGS. 1A and 1B are diagrams for describing a connection relationship between a client terminal and a server in the related art;

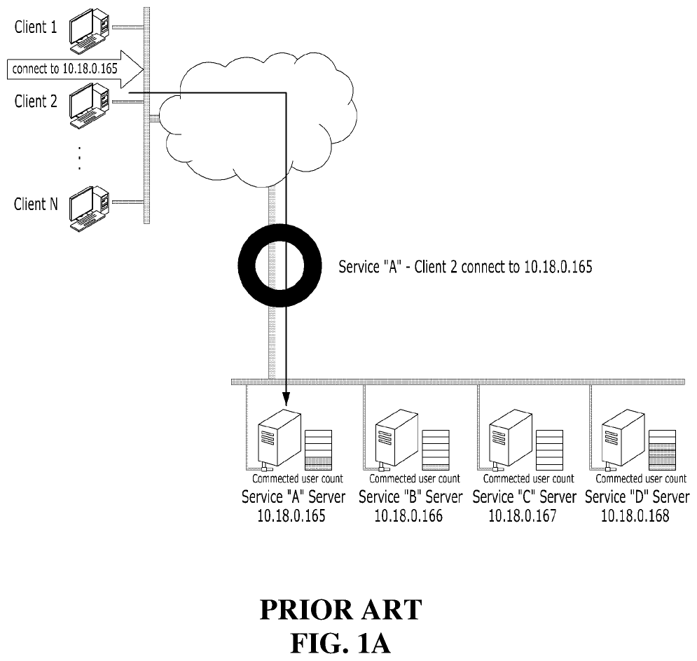

FIG. 2 is a diagram for describing a dynamic network configuration and server extension method according to the present disclosure;

FIG. 3 is a diagram illustrating a lobby server between a global server management unit and a client terminal in a dynamic network configuration and server extension system according to the present disclosure;

FIG. 4 is a diagram for describing another exemplary embodiment of a dynamic network configuration and server extension method according to the present disclosure;

FIG. 5 is a diagram illustrating a flow of providing session information in a dynamic network configuration and server extension method according to the present disclosure;

FIG. 6 illustrates an example of a configuration in the dynamic network configuration and server extension method according to the present disclosure; and

FIG. 7 illustrates an example of information on a local server management unit stored in the global server management unit of the dynamic network configuration and server extension system according to the present disclosure.

### DETAILED DESCRIPTION OF THE PREFERRED EMBODIMENT

The present disclosure may have various modifications and various embodiments and specific embodiments will be illustrated in the drawings and described in detail. However, this does not limit the present disclosure to specific exemplary embodiments, and it should be understood that the present disclosure covers all the modifications, equivalents and replacements included within the idea and technical scope of the present disclosure. In describing each drawing, reference numerals refer to like elements.

Terms including first, second, A, B, and the like are used for describing various constituent elements, but the constituent elements are not limited by the terms. The terms are used only to discriminate one constituent element from another component. For example, a first component may be referred to as a second component, and similarly, the second component may be referred to as the first component without departing from the scope of the present disclosure. A term ‘and/or’ includes a combination of a plurality of associated disclosed items or any item of the plurality of associated disclosed items.

It should be understood that, when it is described that a component is “connected to” or “accesses” another component, the component may be directly connected to or access the other component, or a third component may be present therebetween. In contrast, it should be understood that, when it is described that an element is “directly connected to” or “directly access” another element, it is understood that no element is present between the element and another element.

Terms used in the present application are used only to describe specific embodiments and are not intended to limit the present disclosure. A singular form may include a plural form if there is no clearly opposite meaning in the context. In the present application, it should be understood that terms “include” or “have” indicate that a feature, a number, a step, an operation, a component, a part or the combination thereof described in the specification is present, but does not exclude a possibility of presence or addition of one or more other features, numbers, steps, operations, components, parts or combinations thereof, in advance.

If not contrarily defined, all terms used herein including technological or scientific terms have the same meanings as those generally understood by a person with ordinary skill in the art. Terms which are defined in a generally used dictionary should be interpreted to have the same meaning as the meaning in the context of the related art and are not interpreted as an ideal meaning or excessively formal meanings unless clearly defined in the present application.

Throughout the specification and claims, unless explicitly described to the contrary, a case where any part includes any component will be understood to imply the inclusion of stated components but not the exclusion of any other component.

Hereinafter, a dynamic network configuration and server extension method according to the present disclosure will be described in detail with reference to the accompanying drawings.

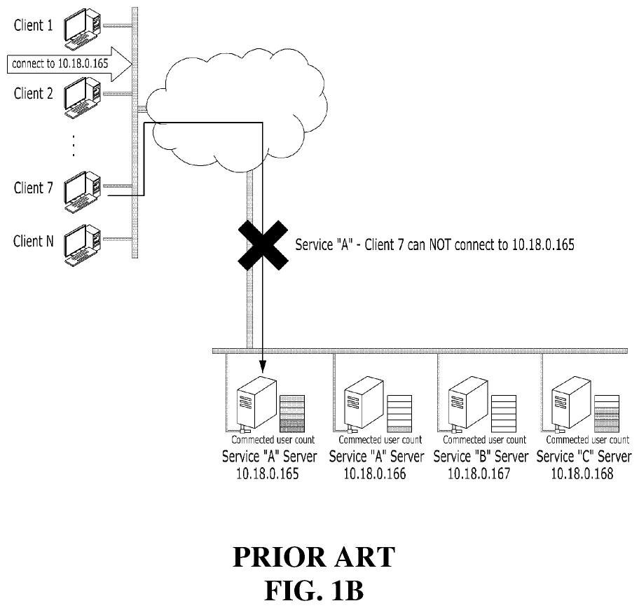

In FIG. 2, a dynamic network configuration and server extension system according to the present disclosure includes a plurality of client terminals 100, a management server 200, and a service server 300.

The client terminal 100 is a user terminal such as a PC, a mobile phone, and a tablet PC that are used by a user to receive specific services such as a game, an image-based video chat, and a virtual reality chat.

The management server 200 is connected to the client terminal 100 and receives a request for service information from the corresponding client terminal 100, checks the status of the server for the requested service, and transmits access information to the client terminal 100.

Meanwhile, the management server 200 is managed by a global server management unit 210, which includes an access management unit 211, a monitoring unit 212, a load balancing unit 213, a restoring unit 214, a service and server information DB 215.

The access management unit 211 provides session information for access, such as IP information, which can be accessed according to an access information request for the service of the client terminal 100.

The session information corresponds to a service name, a bandwidth, a server IP, whether or not a server IP is activated, a network configuration, a maximum available user of the server, channel information, a maximum minimum process of the server, and a comment on available data and is configuration information which is dynamically transmitted by a buffer on a memory in an XML form.

More precisely, the session information provides configuration contents including information that is dynamically generated and transmitted from a local server management unit 310 to be described below for a service that the client desires to receive rather than provided by a file in an XML form.

The monitoring unit 212 monitors the client terminal 100 accessing the service server 300, and determines the number of the client terminals 100 accessing the service server 300 and releasing the access, thereby updating the status of the server.

When the number of the client terminals 100 accessing the related service server 300 to receive a specific service exceeds the allowed number of accessed clients, the load balancing unit 213 distributes a load by allowing the client terminal 100 to access another service server 300 in which the current number of accessed clients is less than the allowed number of accessed clients.

Herein, in the case that there is no other service server 300 that falls short of the number of accessed clients, the load balancing unit 213 may distribute the load by further operating another service server 300 when all the number of accessible client terminals 100 access the service server 300 and thus further accessing to the server is not available.

When the server is shut down due to a sudden and simultaneous access by the plurality of client terminals 100 to the service server 300 providing the specific service due to the participation of the event or the like, the restoring unit 214 restores the corresponding service server 300 through rebooting or load distribution in cooperation with the load balancing unit 213.

The service and server information DB 215 is connected to the access management unit 211, the monitoring unit 212, the load balancing unit 213, and the restoring unit 214 to store and manage the information of the service server 300 providing the service and provides the global server management unit 210 with the stored information when making a request for the accessing information via the specific service of the client terminal 100.

The client terminal 100 may access an accessible service server 300 by receiving the requested access information from the management server 200 as configuration information.

The service server 300 confirms the number of accessed client terminals 100 when the client terminal 100 accesses the service server using the access information provided from the management server 200 and provides the confirmed information to the management server 200 so that the service and server information DB 215 is updated.

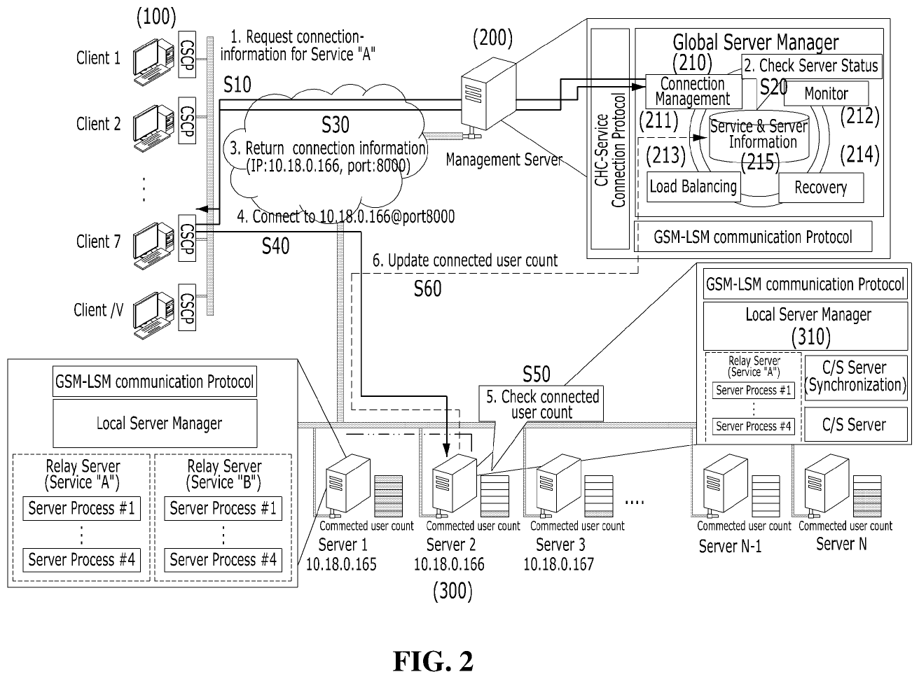

Meanwhile, as illustrated in FIG. 3, a lobby server 400 is further included between the client terminal 100 and the management server 200, and it is preferred that the lobby server 400 inquires which service has been provided when the client terminal 100 accessed the server to classify the service into a sector providing related service and allocate the corresponding service to a server providing the service.

In addition, the lobby server 400 may perform a function of searching for a friend who accesses the service in advance in order to receive a similar service with the user who accessed the service or informing a service access of a friend who accesses the service later.

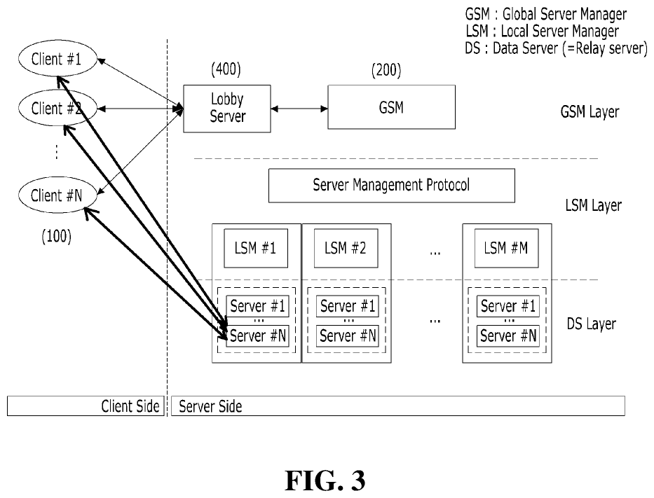

A dynamic network configuration method by the dynamic network configuration and server extension system according to the present disclosure having the above-described configuration will be described with reference to FIGS. 2 and 4.

The management server 200 performs a step of making a request for accessing information via the service server 300 providing a service A before the client terminal 100 accesses the service server 300 in order to receive the service A (S10).

The management server 200 performs a step of receiving the access information about the service A requested from the client terminal 100 and confirming a server status from the service and the server information stored in the service and server information DB 215 of the global server management unit 210 (S20).

For example, in step S20, the management server 200 confirms a server status from the service and the service information, in which the client terminal 100 making a request for accessing information via the service needs to access a service server 2 when accessible client terminals 100 all access a service server 1 among 1 to N service servers 300 providing the service A.

The management server 200 performs a step of providing the access information of the service server 300 with session information together with IP information and the like to the client terminal 100) as a dynamic configuration (S30).

The client terminal 100 performs a step of accessing the service server 300, that is, the service server 2 according to the access information received from the management server 200 (S40).

The service server 300 performs data communication after receiving the access of the client terminal 100 and performs a step of confirming the number of accessed client terminals 100 according to the access of the client terminal 100 (S50).

Thereafter, the service server 300 transmits information about the confirmed number of the client terminals 100 to the global server management unit 210 of the management server 200, and the global server management unit 210 updates the service and server information DB 215 (S60).

As another exemplary embodiment, a dynamic network configuration-based server extension method will be described with reference to FIG. 4.

First, the management server 200 performs a step of making a request for access information on the corresponding service server 300 providing a service A before the client terminal 100 accesses the service server 300 in order to receive the service A (S100).

The management server 200 performs a step of receiving the access information about the service A requested from the client terminal 100 and confirming a server status from the service and the server information stored in the service and server information DB 215 of the global server management unit 210 (S200).

That is, in step S200, the global server management unit 210 of the management server 200 checks the number of client terminals 100 connected to the servers providing the service A and determines whether the number of client terminals 100 connected to a server 1 currently being used exceeds an allowable value.

In step S200, if the number of client terminals 100 connected to the server 1 currently being used does not exceed the allowable value, the global server management unit 210 preferably provides accessible information to the corresponding service server 300 providing the service A.

Meanwhile, in step S200, if the number of client terminals 100 connected to the server 1 currently being used exceeds the allowable value, the global server management unit 210 transmits an execution signal to another service server 300 providing the service A (S300).

Thereafter, the management server 200 performs a step of extending the service server 300 providing the service A by transmitting the execution signal to one service server 300 among 1 to N service servers 300 providing the service A and newly executing the service sever (S400).

The service server 300 performs a step of transmitting the newly executed information to the management server 200 (S500).

The management server 200 performs a step of storing execution information of a new server received from the service server 300 and information on the number of users accessing the corresponding server in the service and server information DB 215, and providing session information, that is, a dynamic configuration together with IP information and the like of the accessible service server 300 newly executed to the client terminal 100 that desires to receive the service A (S600).

The client terminal 100 performs a step of accessing the service server 300 having accessible IP information received from the management server 200 (S700).

The service server 300 performs data communication after receiving the access of the client terminal 100 and performs a step of confirming the number of client terminals 100 changed according to the access of the client terminal 100 (S800).

Thereafter, the service server 300 performs a step of transmitting information about the confirmed number of the client terminals 100, that is, access change information, to the management server 200 so that the global server management unit 210 of the management server 200 updates the service and server information DB 215 (S900).

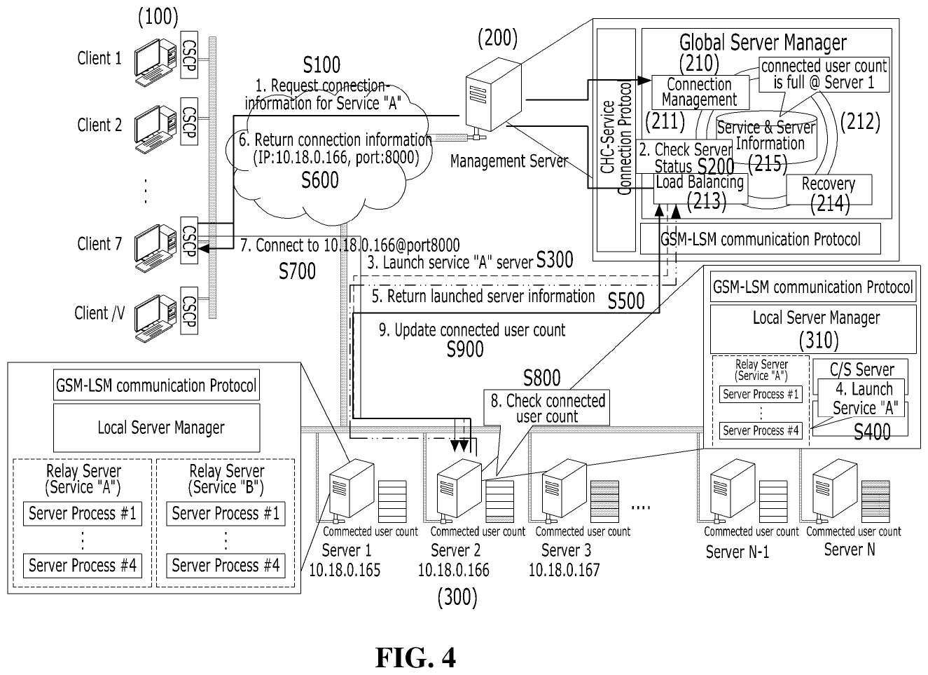

Meanwhile, the configuration, which is the session information provided by the global server management unit 210 to the client terminal 100 in steps S30 and S600, will be described in more detail with reference to FIG. 5.

First, the global server management unit 210 of the management server 200 makes a request for available server information to the local server management unit 310 managing the service server 300 according to a service request by the client terminal 100.

The local server management unit 310 is included in each of the N service servers 300 and determines information of the service server 300 while monitoring the operation of the corresponding service server 300 to transmit the available service server 300 information to the global server management unit 210.

The global server management unit 210 updates the internal service and server information DB 215, extracts service session information from the updated DB, and provides the generated service session information to the client terminal 100.

The session information is configuration information that is dynamically transmitted by a buffer on a memory rather than by a file in an XML form.

More precisely, the session information provides configuration contents including information that is dynamically generated and transmitted from the local server management unit 310 for a service that the client desires to receive rather than provided by a file in an XML form.

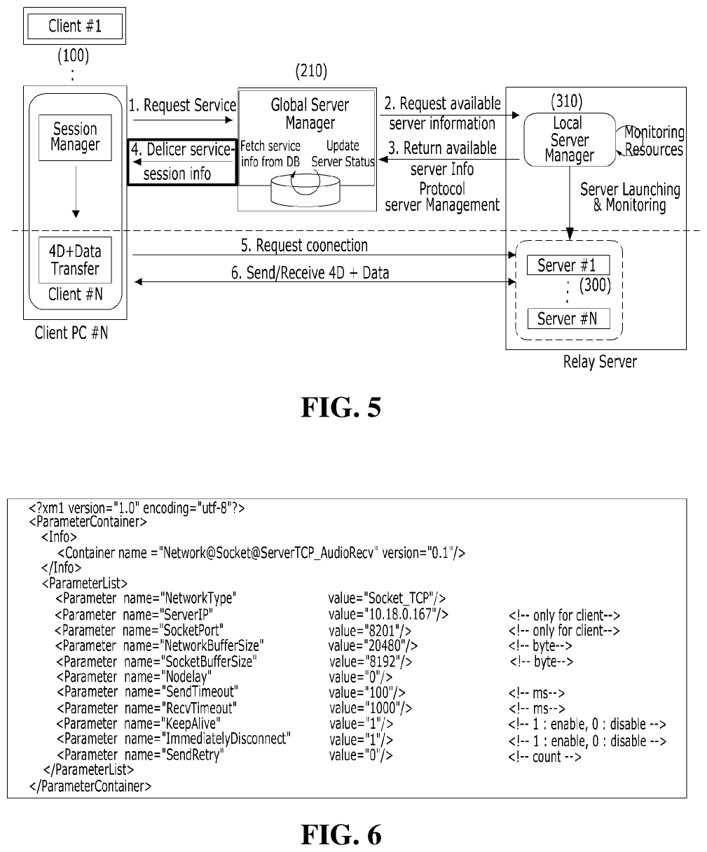

An example of the configuration information is as illustrated in FIG. 6.

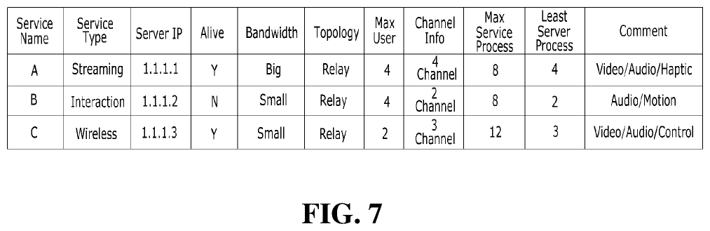

Meanwhile, the global server management unit 210 has information on the service servers 300 in the service and server information DB 215, and the corresponding information is as illustrated in FIG. 7.

As illustrated in FIG. 7, the information on the service server 300 stored in the service and server information DB 215 of the global server management unit 210 includes whether a type of service providing the service is Streaming, Interaction, or Wireless, a server IP, whether the server IP is activated, a bandwidth size, a communication network configuration, a maximum available user of the server, channel information, maximum and minimum processes of the server, comments on available data (video, audio, haptic, motion, and control), and the like.

The above description just illustrates the technical spirit of the present disclosure and various changes and modifications can be made by those skilled in the art to which the present disclosure pertains without departing from an essential characteristic of the present disclosure.

Therefore, the exemplary embodiments of the present disclosure are provided for illustrative purposes only but not intended to limit the technical concept of the present disclosure. The scope of the technical concept of the present disclosure is not limited thereto. The protective scope of the present disclosure should be construed on the basis of the appended claims, and all the technical spirits in the equivalent scope thereof should be construed as falling within the scope of the present disclosure.

What is claimed is:

1. A dynamic network configuration and server extension system comprising:
a plurality of service servers configured to provide a request service according to a service request; and
a management server configured to provide session information of a configuration which is dynamically transmitted by a buffer on a memory for the plurality of service servers providing the requested service and operate additionally the service server in proportional to the service request to extend the server.

2. The dynamic network configuration and server extension system of claim 1, further comprising:
a plurality of client terminals configured to make a request for session information as access information about the plurality of service servers providing the service by accessing the management server and receive the service by accessing a service server accessible according to the corresponding session information.

3. The dynamic network configuration and server extension system of claim 2, wherein the management server is managed by a global server management unit, and
the global server management unit includes
an access management unit configured to provide the session information according to a request for the access information on the service server of the client terminal;
a monitoring unit configured to determine access change information of the client terminal accessing the service server through monitoring to update a status of the service server; and
a load balancing unit configured to distribute a load by additionally operating another service server when all the number of accessible client terminals access the service server and thus further accessing to the server is not available.

4. The dynamic network configuration and server extension system of claim 3, wherein the global server management unit further includes
a restoring unit configured to restore the corresponding service server when the service server is shut down due to over-access of the plurality of client terminals; and
a service and server information DB configured to receive information about the plurality of service servers from the local server management unit of the service server to store and manage the received information.

5. The dynamic network configuration and server extension system of claim 2, further comprising:
a lobby server formed between the client terminal and the management server and configured to inquire services which service has been provided when the client terminal accessed the server and classify the services into a related service providing sector to provide the services or inform pre-access or post-access information of a friend.

6. A dynamic network configuration and server extension method comprising:
(a) receiving by a management server, a request for accessing information via a service server from a client terminal and inquiring a service and server information DB;
(d) providing, by the management server, session information of a configuration which is dynamically transmitted to the client terminal by a buffer on a memory as the access information; and
(e) providing, by the service server, a service to a client terminal to be accessed on the basis of the session information.

7. The dynamic network configuration and server extension method of claim 6, further comprising: after step (a),
(b) additionally operating, by a load balancing unit of a global server management unit managing the management server, another service server by transmitting an execution signal to a local server management unit which manages a service server when there is no accessible service server.

8. The dynamic network configuration and server extension method of claim 7, further comprising: after step (b),
(c) updating, by the global server management unit, a service and server information DB of the management server by receiving information about the service server additionally operated from the local server management unit.

9. The dynamic network configuration and server extension method of claim 8, further comprising: after step (e),
(f) transmitting, by the local server management unit, access change information about the service server to the management server, after confirming an access of the client terminal.

10. The dynamic network configuration and server extension method of claim 9, further comprising: after step (f),
(g) updating, by the global server management unit of the management server, a service and server information DB by reflecting the access change information of the client terminal transmitted from the local server management unit.
